(19) United States
(12) Patent Application Publication
(10) Pub. No.: US 2009/0265290 A1
(43) Pub. Date: Oct. 22, 2009

(54) OPTIMIZING RANKING FUNCTIONS USING CLICK DATA

(75) Inventors: Massimiliano Ciaramita, Barcelona (ES); Vassilis Plachouras, Barcelona (ES); Vanessa Murdock, Barcelona (ES)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/106,226

(22) Filed: Apr. 18, 2008

(51) Int. Cl. G06F 15/18

(52) U.S. Cl. 706/12

(57) ABSTRACT

A system for optimizing machine-learned ranking functions based on click data. The system determines the weighting for each feature of a plurality of features according to a learning model based on the click data. The system selects an element from a plurality of elements for display on a web page based on the weighting of each feature of the plurality of features. The system may rank the items to form a list on the web page based on the weighted features in order of inferred relevance according to the online learning model.

### BACKGROUND

Sponsored search is one of the technologies for today's web search engines. It corresponds to matching and showing ads related to the user query on the search engine results page. Users click on topically related ads and the advertisers typically pay only when a user clicks on their ad. Hence, it may be important to predict if an ad is likely to be clicked, and maximize the number of clicks. In several aspects of web technology, ranking may be used. For example, ranking algorithms are used in the ranking of documents, ads, answers and multimedia content, based on user's queries or web page content (content match). The way to rank lists is to use traditional text similarity metrics, such as cosine similarity, and possibly post-processing the results to include a microeconomic model (for sponsored results).

Sponsored search is the task of placing ads that relate to the user's query on the same page as the search results returned by the search engine. Typically sponsored search results resemble search result snippets in that they have a title, and a small amount of text below the title. When the user clicks on the title he may be taken to the landing page of the advertiser. Search engine revenue may be generated by the sponsored results.

### SUMMARY

The present application describes a system and method for directly, and adaptively, optimizing a ranking function, such as for ranking sponsored search results, using the users click logs, or an incoming stream of click data.

The system determines the weighting for each feature of a plurality of features according to a learning model based on the click data. The system selects an element from a plurality of elements for display on a web page based on the weighting of each feature of the plurality of features. The system may rank the items to form a list on the web page based on the weighted features in order of inferred relevance according to the online learning model.

In another aspect of the system, the features may include, for example, word overlap, cosine similarity, and correlation between the query and the advertisement. The system then selects an item from a group of items for display on a web page based on the weighting of each feature of the plurality of features. The group of items may include advertisements, search results, media content, and similar items. The system may rank the items to form a list on the web page based on the weighted features in order of inferred relevance according to the online learning model.

The system may update the weighting based on a user click event. Alternatively, the system may also evaluate the online learning model by predicting the item that will be clicked in the list based on the query and the online learning model. The results of the evaluation may be stored and used to alter the configuration of the online learning model.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

FIG. 1 is a schematic view of a system for optimizing machine-learned ranking functions based on click data;

FIG. 2 is an example of a search engine results page;

FIG. 3 is a flowchart illustrating a method of optimizing the learning model using click data;

FIG. 4 is a schematic of how blocks are generated from clicked and non-clicked ads for a query;

FIG. 5a is a diagram illustrating a linear decision boundary; and

FIG. 5b is a diagram illustrating non-linear decision boundaries.

### DETAILED DESCRIPTION

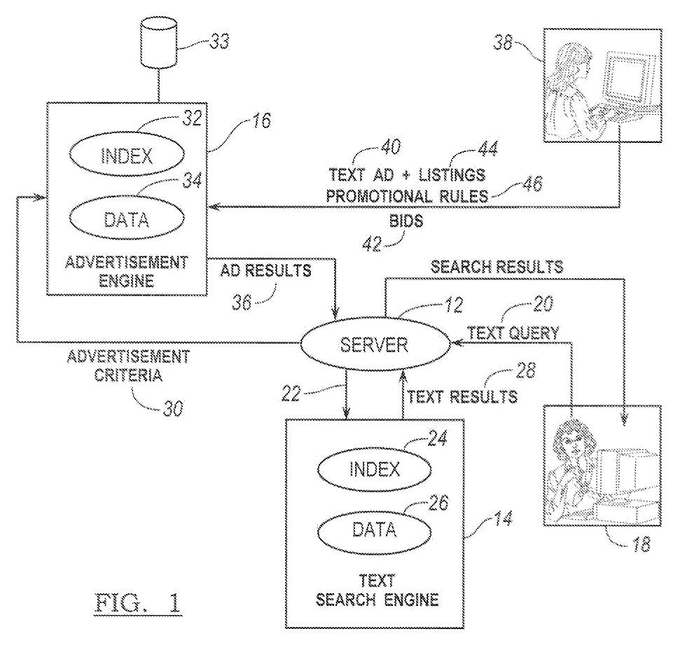

FIG. 1 shows a system 10 which includes a server 12 and an advertisement engine 16. The server 12 is in communication with a user system 18 over a network connection, for example over an Internet connection. In the case of a web search page, the server 12 is configured to receive a text query. 20 to initiate a web page search. The text query 20 may be a simple text string including one or more keywords that identify the subject matter for which the user wishes to search. Upon selection of a search button, the text query 20 may be sent from the user system 18 to the server 12. The text query 20 also referred to as a raw user query, may be simply a list of terms known as keywords.

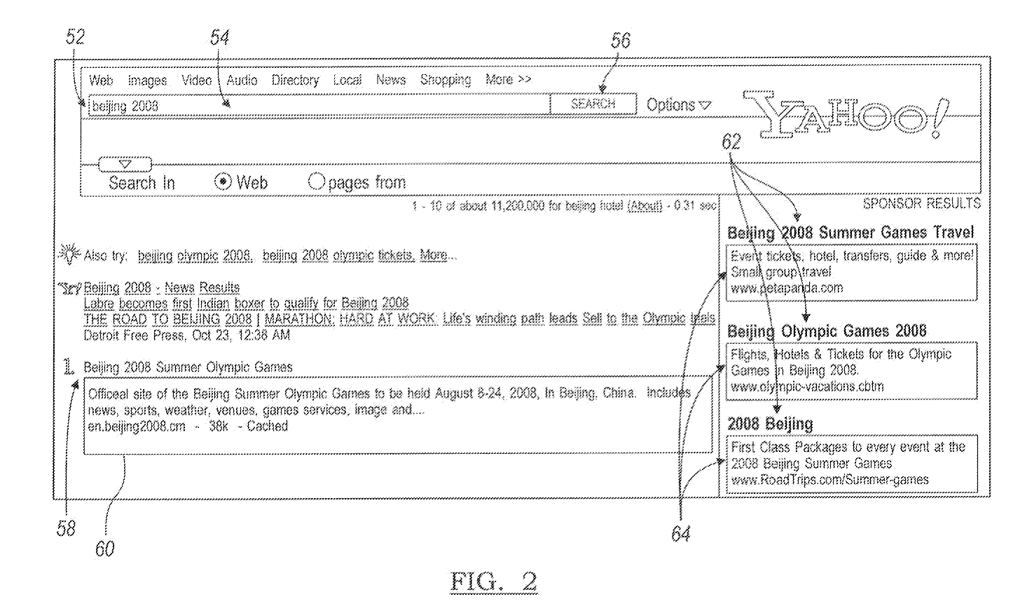

An example of a sponsored search page is provided in FIG. 2. The query string 52 is entered into a query text box 54. The search button 56 may be selected to initiate the sponsored search. Generally, the relevant search results are provided on the left of the web page and include a title 58 and snippets of text, denoted by block 60, providing information about the item. Similarly, a ranked list of advertisements is generated including a title 62 for each advertisement and snippets of text, denoted by blocks 64, providing information about the advertisement.

The server 12 provides the text query 20 to the text search engine 14, as denoted by line 22. The text search engine 14 includes an index module 24 and the data module 26. The text search engine 14 compares the query 20 to information in the index module 24 according to the method described later to determine the relevance of each index entry relative to the query 20 provided from the server 12. The text search engine 14 then generates text search results by ordering the index entries into a list from the highest relevance entries to the lowest relevance entries. The text search engine 14 may then access data entries from the data module 26 that correspond to each index entry in the list. Accordingly, the text search engine 14 may generate text search results 28 by merging the corresponding data entries with a list of index entries. The text search results 28 are then provided to the server 12 to be formatted and displayed to the user.

The server 12 is also in communication with the advertisement engine 16 allowing the server 12 to tightly integrate advertisements with the content of the page and, more specifically, the user query and search results in the case of a web search page. To more effectively select appropriate advertisements that match the user's interest and query intent, the server 12 may be configured to further analyze the text query 20 and generate a more sophisticated set of advertisement criteria 30 or use the text query 20 directly. Alternatively, if the web page is not a web search page, the page content may be analyzed to determine the user's interest to generate the advertisement criteria 30 or text query 20.

In FIG. 1, the advertisement criteria 30 is provided to the advertisement engine 16. The advertisement engine 16 includes an index module 32 and a data module 34. The advertisement engine 16 performs an ad matching algorithm to identify advertisements that match the user's interest and the query intent. The advertisement engine 16 may be in communication with a computer readable medium 33 for storing instructions implementing the ad matching algorithm or other described functions. The advertisement engine 16 compares the advertisement criteria 30 to information in the index module 32 to determine the relevance of each index entry relative to the advertisement criteria 30 provided from the server 12. The scoring of the index entries may be based on the method described below and may consider also advertisement criteria, as well as the bids and listings of the advertisement. The bids are requests from an advertiser to place an advertisement. Each bid may have an associated bid price for each selected domain, keyword, or combination relating to the price the advertiser will pay to have the advertisement displayed. Listings provide additional specific information about the products or services being offered by the advertiser. The listing information may be compared with other advertisement criteria to match the advertisement with the query. An advertiser system 38 allows advertisers to edit ad text 40, bids 42, listings 44, and rules 46. The ad text 40 may include fields that incorporate, domain, general predicate, domain specific predicate, bid, listing or promotional rule information into the ad text.

The advertisement engine 16 may then generate advertisement search results 36 by ordering the index entries into a list from the highest relevance entries to the lowest relevance entries. The advertisement engine 16 may then access data entries from the data module 34 that correspond to each index entry in the list from the index module 32. Accordingly, the advertisement engine 16 may generate advertisement results 36 by merging the corresponding data entries with a list of index entries. The advertisement results 36 are then provided to the server 12. The advertisement results 36 may be provided to the user system 18 for display to the user.

The system 10 may implement an online learning model in one or both of the advertisement engine 16 and the text search engine 14. Each online learning model may operate in three modes for training, normal run, and evaluation. In each mode, a machine learned ranking function based on click data is utilized. The click data may correspond to a block including the clicked advertisement, the higher ranked non-clicked advertisements, and the query. As such, the system has ranking functions that include ranking parameters that may be optimized using the blocks directly. The click data may be obtained from the server 12 through a stream, without the need of unbiasing the click data. Exploratory results on actual click logs have shown that this approach produces improved results over known methods. In addition, the system 10 can also operate on editorial data, without the cost of producing the annotated data. Such a method thus has the potential to build more robust, adaptive and up-to-date ranking systems.

The ranking function can be learned using a machine learning framework, allowing the combination of high numbers of features and explicit minimization of the error on empirical data, or maximizing revenue. Machine learned ranking functions tend to produce higher-quality matching. A machine-learned ranking function can be trained on manually evaluated query-object pairs, or from click data based on real user feedback. One advantage of using click logs is that there is an enormous amount of data for training and evaluation. Additionally, maximizing click prediction quality for sponsored search and content match amounts to directly maximizing revenue. One problem with using click logs is that click data is characterized by a strong positional bias and unbiasing is not a well understood problem.

Generally, the final ranking of ads takes into account the amount bid by the advertiser and, more generally, the micro-economic model adopted by the search engine to maximize revenue, relevance, or quality of the ads returned. Users are more likely to click ads that are relevant to their interest. In fact, there is evidence that the level of congruence between the ad and the context has a significant effect even in the absence of a conscious response such as a click. If it is assumed that congruency equates to topical similarity or “relevance”, the one goal may be to show the ads that are most similar to the user's query in the sponsored results. With this in mind, it may be beneficial to place ads in the sponsored results that are a good match for the user's query. In the description of the method below, emphasis is placed on the issue of improving the quality of the ads proposed as relevant to the query. However, a micro-economic model may also be considered in combination with the described method to compile the ranked list of ads to be displayed.

Aside from the difficulties in assessing the similarity of an ad to a query that stem from the sparseness of the representation of both the query and the ad, the task of placing ads is complicated by the fact that users click on ads for a wide variety of reasons that are not reflected in the similarity of an ad to a query. For example, there is a strong positional bias to user clicks. Users are much more likely to click on items at the top of a ranked list of search results than items lower in the ranking. This makes using the click data to learn a ranking function over the ads and to evaluate the system more difficult. Specifically, user clicks are not an indication of absolute relevance. Rather, the user click only indicates that the items viewed above the current position that were not clicked are less relevant than the item clicked. However, this observation implies that positive and negative examples can be extracted from query logs in a meaningful way, avoiding the complexities and noise of click-through rate estimation.

Click data can be also used directly for evaluating a learning model. Previous works have ultimately relied on editorial data for evaluation. However, according to method described consistent results are obtained across different ranking methods and different feature sets.

The problem of ranking a set of ads given a query is formulated as a learning task. Further, three learning methods of increasing complexity have been implemented based on the perceptron algorithm: a binary linear classifier, a linear ranking model and a multilayer perceptron, or artificial neural net. Described online learning methods suit the task of learning from large amounts of data, or from a stream of incoming feedback from query logs. Studies have determined that accuracy increases with the complexity of the model. Retrieving ads is complex because the text is sparse.

Several classes of features have been investigated for content match, the task of ranking ads with respect to the context of a web page, rather than a query. The cosine similarity between a query and ad may be used as a baseline. Then, the ad is decomposed and the similarity of individual components of the ad and the query are used as features. Next, a class of language-independent, knowledge free, features are evaluated based on the distributional similarity of pair words which have been used successfully in content match, and can be extracted from any text collection or query log. These features measure the similarity between two texts independently of exact matches at the string level and are meant to capture indirect semantic associations. In content match, there are many words that can be extracted from a web page to compute such features, while in sponsored search there are only the terms in the query. Across all learning methods these features produce the best results.

In summary, the method described herein uses click-data directly for learning and evaluation purposes which is a desirable property in the context of large scale systems, that otherwise have to rely exclusively on editorial data, or carry out noisy estimations of click-through rates. The test results verify empirically that different methods of increasing complexity can be applied to the task and generate consistent results. This is important because it supports the hypothesis that the evaluation is consistent across different methods. On the learning side, it also shows that taking into account pairwise information in training is beneficial in machine-learned ranking, even in noisy settings. Finally, the test results provide empirical evidence on the utility of a class of simple features for ranking based on lexical similarity measures, also in the task of query-based ranking, and thus possibly also in document retrieval and search in general.

Referring to FIG. 3, a flowchart illustrating a method 100 for optimizing ranking functions based on click data is provided. The method 100 starts in block 102 where the system accesses historical click data. In block 104, the system generates weighting for each feature by optimizing the learning model for the historical click data. Blocks 102 and 104 can be thought of as an initialization phase.

In block 106, a query is received by the system. In one example, query may be received in the advertisement engine from a sponsored search. The system then ranks the elements (i.e. advertisements for a sponsored search) based on features and weighting derived from the learning model, as denoted by block 110. In block 112, the system captures the user click and stores it along with the query and advertisement information. In block 114, the system determines if the user click is to be allocated for evaluation of the learning model.

If the user click is to be allocated for evaluation of the learning model, the method follows line 116 to block 118. In block 118, the learning model is evaluated using the user click. The user click may be processed in the form of a stream to provide continuous evaluation or, alternatively, stored for batch evaluation with a group of other user clicks. The method 100 then follows line 128 to block 106 where the process is repeated. If the user click is not to be allocated for evaluation the method 100 follows line 120 to block 122.

In block 122, the system determines if the user click is to allocated for updating of the learning model. If the user click is to be alocated for updating of the learning model, the method follows line 124 to block 126. In block 126, the learning model is updated using the user click. The user click may be processed in the form of a stream to provide continuous updating or, alternatively, stored for batch updating with a group of other user clicks. The method 100 then follows line 128 to block 106 where the process is repeated. If the user click is not to be allocated for evaluation the method 100 follows line 128 to block 106 directly where the process is repeated. Additional decision points may also be added to modify the learning model parameters based on the continuous or batch evaluations.

The method is based on the idea of compiling ground truth data from click data. According to one methodology, the only reliable conclusion that can be drawn from a click on a list of ranked items is that the clicked item is more relevant than all non-clicked items ranked higher than the clicked item itself.

This methodology can be better understood in light of the following example. The example includes a list of 6 ranked objects listed as o1-o6. The listed objects in brackets have been clicked during the session:
[o1] o2 [o3] o4 o5 [o6]

From this example, it can be deduced that o3 is more relevant than o2, and that o6 is more relevant than o5, o4, and o2. No reliable conclusion can be made about o1. Although o1 was clicked, it was read first. The example could refer to ranking documents, or ads based on a query or web page content.

A block corresponds to a click or group of clicks. Each block can be used either for training or evaluating a ranking function directly. For example, one can learn from blocks as units, learning a pairwise ranking function (e.g., SVM rank, or perceptron ranking) or learn a regression model in which positive and negative datapoints are used independently of their original block. Another option is to learn a binary classifier, again ignoring the block, structure. However, it is important to realize, that even if not used for learning, blocks are important for generating and defining a positive/negative instance. The idea of optimizing directly on blocks is also novel.

Several experiments have been preformed on click data from sponsored search logs using models of incremental complexity, and different feature sets. The results show that the method for evaluation is consistent, i.e. produced the same patterns of results, than ranking functions trained and evaluated on editorial data. The results also indicated that more complex models outperform simpler models, while richer models (in feature representation) outperform less expressive models based on simpler feature representations.

Currently click logs are used mainly to extract features for ranking, while ranking functions are mostly trained and evaluated on editorial data. In addition, current training routines based on click data need to unbias the click log data which is complicated and possibly inaccurate.

The proposed method allows training and evaluation directly on click data, thus allowing larger scale and faster development cycles for complex ranking functions. In addition, the method can be used in combination with other methods, i.e. based on editorial data. Finally, it can be used for any ranking task which produced query logs, such as search or content match, multimedia retrieval etc. Finally, if learning with online models training of the ranking function can be adaptive and continuous based on a stream of user's feedbacks.

Employing user clicks to train and to evaluate a sponsored search system is an excellent solution, since the goal in sponsored search is maximizing the number of clicks. However, user clicks generally cannot be used in a straight-forward manner because they have a strong positional bias, and they only provide a relative indication of relevance. The strong positional bias is because highly ranked results or ads may be clicked based of their rank position and not their relevance. For example, a user may click on the top ranked ad and then click on the third ad in the ranking, even if the third ad may be more relevant to his query. The reason for this bias is that users are likely to scan sequentially the ranked list of items and may click on an item before, or without, scanning the whole list.

To investigate how to employ user clicks to train and evaluate a sponsored search system, a set of queries and the corresponding ads were collected from the logs of the Yahoo!® web search engine. The corresponding ads are ads that had been shown with the set of queries on the right-hand side of the search engine results page. The queries were sampled until a sufficiently large number of distinct clicked ads were collected. Queries with three or more query terms were sampled because longer queries are more likely to lead to higher conversion rates. In other words, users issuing longer queries are more likely to visit a web site and perform a transaction. In addition, only one click for a query-ad pair were considered from one user per day.

To facilitate training a conservative assumption was made that a click can only serve as an indication that an ad is more relevant than the ads ranked higher but not clicked, but not as an absolute indication of the ad relevance. In this setting, the clicks on the top ranked ad do not carry any information, because the top ranked ad cannot be ranked any higher. In other words, there is no discriminative pairwise information. Hence, such clicks were not considered in the experiments. For each clicked ad, a block was created which consists of the clicked ad and the non-clicked ads that ranked higher, for a total of 123,798 blocks. In each block, a score of “+1” was assigned to the clicked ad and “−1” to the ads that were ranked higher but were not clicked.

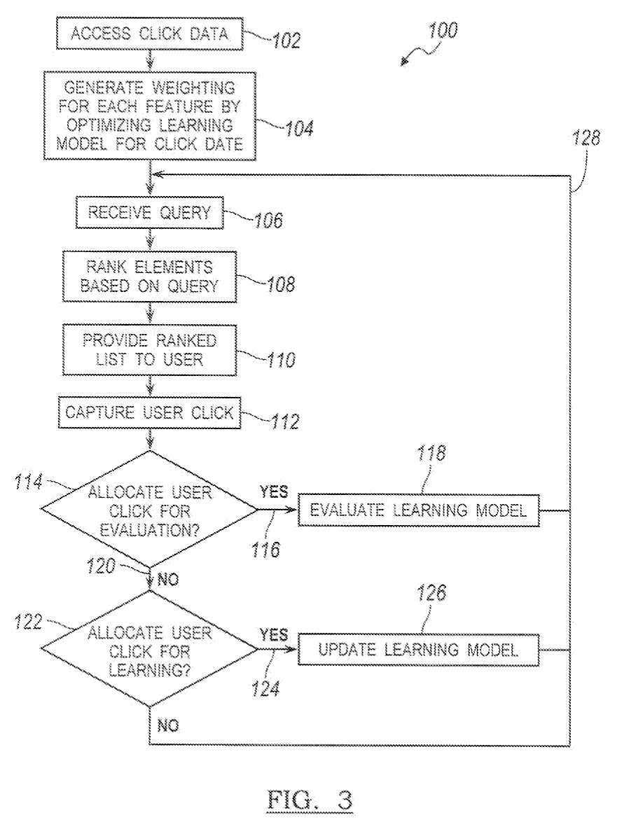

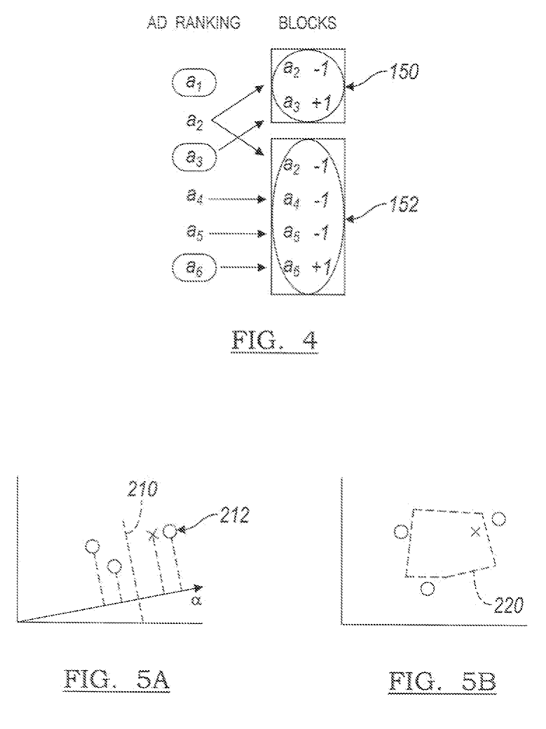

FIG. 4 shows an example of the score assignment process. On the left-hand side of FIG. 4, the ranking of six ads for a query are shown. The ellipsis around ads a₁, a₃ and a₅ denote that these ads were clicked by the user who submitted the query. The “gold-standard” blocks of ads, shown on the right-hand side of FIG. 4, are generated in the following way. First, the click on ad a₁ was ignored since this ad was already ranked first and it was clicked. Then, a first block 150 of ads is formed with a₂ and a₃, assigning scores of “−1” and “+1”, respectively. Next, a second block 160 of ads is formed consisting of a₂, a₄, a₅ with scores “−1” and a₆ with score “+1”.

Learning with clicks can involve arbitrarily large amounts of data, or even learning from a continuous stream of data. Online learning algorithms are the most natural choice for this type of task, since the data need not be considered (or stored in memory) all at once. Rather, each pattern is used for learning in isolation. As a general online learning framework, the perceptron algorithm may be a chosen and was used in the testing described. The perceptron algorithm was invented by Frank Rosemblatt in 1958, and was initially criticized because of its inability to solve non-linear problems. In fact, the perceptron algorithm, like support vector machines (SVM) and other methods, can learn non-linear models by means of kernel functions in dual algorithms, or by means of higher-order feature mappings in the primal form, or even by means of multilayer architectures.

The perceptron algorithm has received much attention in recent years for its simplicity and flexibility. In particular, the perceptron algorithm has been popular in natural language processing, where it has been successfully applied to several tasks such as syntactic parsing, tagging, information extraction and re-ranking. The perceptron algorithm may be preferred over other popular methods, such as SVM, for which incremental formulations have been proposed, because the accuracy of well-designed perceptrons (i.e., including regularization, margin functions, etc.) often perform as well as more complex methods at a smaller computational cost. Moreover, the simplicity of the perceptron algorithm allows easy customization, which can be important in large scale settings. One perceptron model was benchmarked on a ranking task and yielded results comparable to more complex SVM and Boosting methods.

Three primary approaches are provided for learning rank ads based on click data: classification, ranking, and non-linear regression. The general setting involves the following elements. A pattern is a vector of features extracted from an ad-query pair (a, q), x ∈ IR^{d}. Each pattern xᵢ is associated with a response value yᵢ ∈ {−1, +1}. In classification, a vector for a pair which has not been clicked is associated with −1, also referred to as class yₒ. Similarly, a vector for a pair which has been clicked is associated with +1, also referred to as class yᵢ. The goal of learning is to find a set of parameters (weights) α which are used to assign a score F(xᵢ; α) to patterns such that F(xᵢ; α) is close to the actual value yᵢ. In particular, the clicked ad may be predicted for a block of ads to evaluate performance of the model.

In a classification framework the goal is to learn a function which is able to accurately assign a pattern to either the clicked or not-clicked class. Patterns in the data are used independently of one another in training and the classifier simply finds a weight vector which assigns each pattern to the correct class. After learning, the classifier can be used to identify the most likely clickable pattern in a block.

The basic classifier is a binary perceptron algorithm. The basic model may be extended by averaging and adding an uneven margin function. Averaging is a method for regularizing the classifier by using—for prediction after training—the average weight vector of all perceptron models posited during training. The uneven margin function is a method for learning a classifier with large margins for cases in which the distribution of classes is unbalanced. Since non-clicked ads are more numerous than clicked ads, the learning task is unbalanced and the uneven margin function pushes learning towards achieving a larger margin on the positive class. The binary perceptron uses the sign function as a discriminant:

F(x;α)=Sgn(<x, α>) (1)

The α variable is learned from the training data. In one example, the model has two adjustable parameters, the first is the number of instances T to use in training, or the number of passes (epochs) over the training data. The second concerns a constant τ₁ of the uneven margin function that is used in training to define a margin on the positive class. While training, an error is made on a positive instance of x, if F(x; α)≦τ₁. In addition, the parameter on the negative class τ₀=0 and is ignored. The learning rule is:

The ranking function defined on the binary classifier is simply the inner product between the pattern and the weight vector:

Sₒₚₘ=<x, α> (3)

In evaluation, Sₒₚₘ is used to rank ads in each block.

Another method of modeling click feedback is by using a ranking algorithm. The general intuition is to exploit the pairwise preferences induced from the data by training on pairs of patterns, rather than independently on each pattern. Let Rb be a set of pairs of patterns for a block b, such that (xᵢ, xⱼ) ∈ R_{b} [symbol] r(yi)<r(yⱼ), where r(yᵢ) is the rank of xᵢ in b. For example, in this case, either yᵢ=1 and r(yᵢ)=1, or yᵢ=−1 and r(yᵢ)=2.

Given a weight vector α, the score for a pattern x is again the inner product between the pattern and the weight vector:

Sᵣₙₖ=<x₁ α> (4)

However, the error function depends on pairwise scores. In training, for each pair (xᵢ, xⱼ) ∈ R_{b}, the score Srnk(xᵢ−xⱼ) is computed. Given a margin function g and a positive learning margin τ, if Srnk(xi−xj)≦g(r(yi), r(yj))τ, an update is made as follows:

α^{t+1}=α¹+(xₜ−xᵢ)τ (5)

In particular, because the discriminant function is an inner product, Sᵣₙₖ(xᵢ−xⱼ)=Sᵣₙₖ(xᵢ)−Sᵣₙₖ(xⱼ). By default g(i, j)=(1/i−1/j) is used as a margin function. Although there are only two possible ranks in our setting, ideally training on pairs provides more information than training on patterns in isolation. For regularization purposes, averaging is applied also to the ranking perceptron.

One possible drawback of the previous methods is that they are limited to learning linear solutions. To improve the expressive power of the proposed ranking function, within the online perceptron approach, multilayer models may be applied. The topology of multilayer perceptrons include at least one non-linear activation layer between the input and the output layers. Multi-layer networks with sigmoid non-linear layers can generate arbitrarily complex contiguous decision boundaries, as shown in FIGS. 5a and 5b. FIG. 5a illustrates an example of learning decision boundaries based on a linear model. FIG. 5b illustrates an example of learning decision boundaries based on a non-linear model such as multilayer regression. In both FIGS. 5a and 5b, x denotes positive (clicked) patterns while circles denote negative (non-clicked) patterns. The linear model utilizes a type of threshold as indicated by line 210. The linear model may classify some of the patterns correctly but may misclassify certain indicators with complex relationships, such as the negative classifier denoted by arrow 212. Alternatively, non-linear models can find complex decision boundaries, as denoted by line 220, to solve non-linearly separable cases.

Multi-layer networks have been used successfully in several tasks, including learning to rank. The multilayer perceptron can be fully connected three-layer network with the following structure:

1. Input layer: d units x₁, x₂, . . . , x_{d}+a constant input xₒ=1

2. Hidden layer: n_{H} units w₁, w₂, . . . , w_{nH}+a constant weight wₒ=1

3. Output layer: one unit z

4. Weight vector: α² ∈ IR^{nH}+a bias unit α₀²

5. Weight matrix: α¹ ∈ IR^{d×nH}+a bias vector αᵤ¹ ∈ IR^{nH}

The score Sₘₗₚ(x) of a pattern x is computed with a feedforward pass:

$${S}_{mlp} ( x ) = {\sum }_{j = 1}^{nH} {α}_{j}^{2} {w}_{j} + {α}_{0}^{2} = 〈 {α}^{2} , w 〉 \qquad ( 6 )$$

where wⱼ=f(netⱼ), and

$${net}_{j} = {\sum }_{i = 1}^{d} {α}_{ij}^{1} {x}_{i} + {α}_{0}^{1} = 〈 {α}_{j}^{1} , x 〉 \qquad ( 7 )$$

The activation function f(net) of the hidden unit is a sigmoid:

$$f ( net ) = \frac{1}{1 + {exp}^{- α net}} \qquad ( 8 )$$

Supervised training begins with an untrained network whose parameters are initialized at random. Training is carried out with back propagation. As such, an input pattern xᵢ is selected and its score is computed with a feedforward pass. Then the score is compared to the true value yᵢ. The parameters are, thereafter, adjusted to bring the score closer to the actual value of the input pattern. The error E on a pattern xᵢ is the squared difference between the guessed score Sₘₗₚ(xᵢ) and the actual value yᵢ of xᵢ, or for brevity

$$( {y}_{i} - {s}_{i} ) , E = \frac{1}{2} {( {y}_{1} - {s}_{i} )}^{2} .$$

After each iteration t, α is updated component-wise to α^{t+1} by taking a step in weight space which lowers the error function:

$$\begin{matrix}{α}^{t + 1} = {α}^{t} + Δ {α}^{t} \\ = {α}^{t} + η \frac{\partial E}{\partial {α}^{t}} {α}^{t}\end{matrix} \qquad ( 9 )$$

where ρ is the learning rate, which affects the magnitude, or speed, of the changes in weight space.

The weight update for the hidden-to-output weights is:

Δα_{hu 2}=ηδwₜ (10)

where δ=(yᵢ−zᵢ).

The learning rule for the input-to-hidden weights is:

Δαᵢⱼ¹=ηxⱼƒ′(netⱼ)αᵢⱼ¹δ. (11)

where f′ is the derivative of the non-linear activation function.

An estimate was determined empirically for the accuracy of the methods implemented. On all evaluation metrics the ranking perceptron achieves scores comparable to SVM on the OHSUMED and TD2003 datasets, and comparable to RankBoost on the TD2004 dataset. The multilayer perceptron outperforms the ranking perceptron on exploratory runs, but extensive comparisons were not carried out in this context.

A range of features, from simple world overlap and textual similarity features to statistical association between terms from the query and the ads, are used for learning a ranking models. Four features can be computed that assess the degree of overlap between the query and the ad materials. The first feature has a value of one if all of the query terms are present in the ad:

if (∀ t ∈q)t ∈ α, F₁=1, and 0 otherwise. (12)

The second feature has a value of one if some of the query terms are present in the ad:

if ∃ t ∈ q such that t ∈ a, F₂=1, and 0 otherwise. (13)

The third feature has a value of one if none of the query terms are present in the ad:

if [symbol] ∃ t ∈ q such that t ∈ a, F₃=1, and 0 otherwise. (14)

The fourth feature is the percentage of the query terms that have an exact match in the ad materials.

Cosine similarity may also be used as a feature for the online learning model. The cosine similarity feature sim(q, a) is computed between the query q and the ad a as follows:

$$sim ( q , a ) = \frac{{\sum }_{t ∈ q ⋂ a} {w}_{q t} {w}_{i π}}{\sqrt{{\sum }_{t ∈ q} {w}_{q t}^{2}} \sqrt{{\sum }_{t ∈ a} {w}_{i π}^{2}}} \qquad ( 15 )$$

where the weight wₜ of a term in q or a corresponds to the ff−idf weight:

$${w}_{t} = tf \cdot {log}_{2} \frac{N + 1}{{n}_{t} + 0.5} \qquad ( 16 )$$

where tf is the frequency of a term in q or in α. When considering queries q, tf is expected to be uniformly distributed with one being the most likely value, because terms are not likely to be repeated in queries. In addition, N corresponds to the total number of available ads and nt corresponds to the number of ads in which term t occurs.

The tf−idf weight wₐₜ of term t in a is computed in the same way. The cosine similarity between q and each of the fields of the ads may also be computed, that is, the ad title aₜ, the ad description ad, and its bidded terms a_{b}. In all cases, a stemming algorithm has been applied and stop words have been removed.

Cosine similarity has been used effectively for ranking ads to place on web pages in the setting of contextual advertising. A difference with the current method is that in the case of contextual advertising, the cosine similarity is computed between the web page and ad. While there are more complex similarity functions that have been developed and applied for the case of computing the similarity between short snippets of text, cosine similarity is used because it is parameter free and inexpensive to compute. Queries and ads are both short snippets of text, which may not have a high vocabulary overlap. To address this issue, two features are considered based on measuring the statistical association of terms from an external corpus.

Various correlation algorithms may be used as a feature for the online learning model. One measure of association between terms is pointwise mutual information (PMI). PMI is computed between terms of a query q and the bidded terms of an ad a. PMI is based on co-occurrence information, which is obtained from a set of queries submitted to the Yahoo! search engine:

$$PMI ( {t}_{1} , {t}_{2} ) = {log}_{2} \frac{P ( {t}_{1} , {t}_{2} )}{P ( {t}_{1} ) P ( {t}_{2} )} \qquad ( 17 )$$

where t₁ is a term from q, and t₂ is a bidded term from the ad a. P(t) is the probability that term t appears in the query log, and P(t₁, t₂) is the probability that terms t₁ and t₂ occur in the same query.

The pairs of t₁ and t₂ are formed by extracting the query terms and the bidded terms of the ad. Only pairs of terms consisting of distinct terms with at least one letter are considered. For each pair (q, a) two features are used: the average PMI and the maximum PMI, denoted by AvePMI and MaxPMI, respectively.

Another measure of association between terms is the x² statistic, which is computed with respect to the occurrence in a query log of terms from a query, and the bidded terms of an ad:

$${x}^{2} = \frac{\vert L \vert {( {o}_{11} {o}_{22} - {o}_{12} {o}_{21} )}^{2}}{( {o}_{11} + {o}_{12} ) ( {o}_{11} + {o}_{21} ) ( {o}_{12} + {o}_{22} ) ( {o}_{21} + {o}_{22} )} \qquad ( 18 )$$

where |L| is the number of queries in the query log, and o₁₁ are defined in Table 1

TABLE 1

| | t₁ | [symbol] t₁ |
|---|---|---|
| t₂ | o₁₁ | o₁₂ |
| [symbol] t₁ | o₂₁ | o₂₂ |

For example, o₁₁ stands for the number of queries in the log, which contain both terms t₁ and t₂. Similarly, o₁₂ stands for the number of queries in the log, in which term t₂ occurs but term t₁ does not. The X² statistic is computed for the same pairs of terms on which the PMI features are computed. Then, for each query-ad pair, the number of term pairs are counted that have a X² higher than 95% of all the computed xᵢ values.

An overview of the features used is shown in Table 2

TABLE 2

| Feature | | |
|---|---|---|
| Name | Abbrev. | Description |
| | | Word Overlap Features |
| NoKey | O | 1 if no query term is present in the ad materials; 0 otherwise |
| SomeKey | | 1 if at least one query term is present in the ad materials; 0 otherwise |
| AllKey | | 1 if every query term is present in the ad materials; 0 otherwise |
| Percent Key | | The number of query terms present in the ad materials divided by the |
| | | number of query terms |
| | | Cosine Similarity Features |
| Ad | B | The cosine similarity between the query and the ad materials (baseline) |
| Title | F | The cosine similarity between the query and the ad title |
| Description | | The cosine similarity between the query and the ad description |
| Bidterm | | The cosine similarity between the query and the bidded terms |
| | | Correlation Features |
| AvePMI | P | The average pointwise mutual information between terms in the query |
| MaxPMI | | and terms in the ad |
| | | The maximum pointwise mutual information between terms it the query |
| | | and terms in the ad |
| CSQ | C | Number of query-ad term pairs that have x² statistic in the top 5% of |
| | | computed x² values. |

All feature values may be normalized across the entire dataset with the z-score, in order to have 0 mean and unit standard deviation. As such, each feature xᵢ can be normalized as:

$$z = \frac{{x}^{i} - {μ}_{i}}{{σ}_{i}} \qquad ( 19 )$$

In addition, each data vector can be augmented with a bias feature which has a value of one for every example, and serves as a prior on the response variable.

For testing, the dataset was split into 1 training set, 5 development sets and 5 test sets, so that all the blocks for a given query are in the same set. The exact number of blocks for each of the development and test sets is given in Table 3. The training set consists of a 109,560 blocks.

TABLE 3

| Part | Development size | Test size |
|---|---|---|
| 1 | 1358 | 1445 |
| 2 | 1517 | 1369 |
| 3 | 1400 | 1488 |
| 4 | 1408 | 1514 |
| 5 | 1410 | 1329 |

A ranking algorithm produced a score for each query-ad pair in a block. The ads were ranked according to this score. Because of the way the data was constructed and to account for the relative position of clicks, each block has only one click associated with it. For this reason, the precision at rank one and the mean reciprocal rank are evaluated. The precision at rank one indicates how many clicked ads were placed in the first position by the ranker. The mean reciprocal rank indicates the average rank of the first clicked ad in the output of the ranker. The mean reciprocal rank is computed as:

$$MMR = \frac{1}{n} {\sum }_{i = 1}^{n} \frac{1}{{rank}_{i}} \qquad ( 20 )$$

where rankᵢ is the rank of the clicked ad according to the ranking function score and n is the total number of blocks. The MRR score gives an indication of how far on average the ranker's guess is in the ranked list.

All adjustable parameters of the learning models were fixed on the development datasets. The best values were selected by monitoring the average accuracy over the 5 development folds, the optimal values on development were used on the evaluation set. All models were trained with a stochastic protocol, choosing a training instance at random without replacement: a block for the ranking case, a single pattern for the classification and multilayer models.

In the classification case, the parameters T and τ were set. Three values for τ₁, (1, 10 and 100) were evaluated, and 100 was found to give the best results. As for the number of iterations, all the models (not only in classification) tended to converge quickly, rarely requiring more than 20 iterations to find the best results.

In the ranking model, the positive learning margin τ was optimized, in addition to the number of iterations T. The best results were around the value τ=1 which was used in all experiments with ranking perceptron.

The multilayer model has a number of adjustable parameters, some of the parameters were kept with default values; e.g., the sigmoid, a=1.716. The network weights for the hidden-to-output units were initialized uniformly at random in the

$$interval -- \frac{1}{\sqrt{( nH )}} 〈 {α}_{i}^{2} 〈 \frac{1}{\sqrt{( nH )}} .$$

The input-to-hidden weights were initialized randomly in the

$$interval - \frac{1}{\sqrt{( d )}} 〈 {α}_{ij}^{2} 〈 \frac{1}{\sqrt{( d )}} .$$

On the development data, hidden layers with 50 units and η=0.01, produced fast training and stable results. These values were fixed on all experiments, involving the multilayer model. The number of iterations was set on the development set, running a maximum of 50 iterations².

The baseline model has only one feature, the cosine similarity between the ad and the query with tf−idf weights. In practice since a bias term exists in each type of classifier, effectively two features exist.

TABLE 4

| | Classification | | Ranking | | Regression | |
|---|---|---|---|---|---|---|
| Feature set | Prec at 1 | MRR | Prec at 1 | MRR | Prec at 1 | MRR |
| B | 0.322 | 0.582 ± 0.306 | 0.333 | 0.590 ± 0.307 | 0.328 | 0.585 ± 0.307 |
| B + O | 0.319 | 0.578* ± 0.306 | 0.352 | 0.602* ± 0.310 | 0.343 | 0.596* ± 0.309 |
| B + F | 0.341 | 0.593* ± 0.309 | 0.347 | 0.597* ± 0.310 | 0.374 | 0.615* ± 0.314 |
| B + F + O | 0.357 | 0.605* ± 0.311 | 0.357 | 0.605* ± 0.311 | 0.371 | 0.614* ± 0.313 |
| B + F + O + P | 0.357 | 0.604* ± 0.311 | 0.359 | 0.606* ± 0.311 | 0.374 | 0.617* ± 0.313 |
| B + F + O + C | 0.357 | 0.601*† ± 0.310 | 0.364 | 0.610*† ± 0.311 | 0.381 | 0.619*† ± 0.315 |
| B + F + P + C + P | 0.360 | 0.606* ± 0.311 | 0.363 | 0.609* ± 0.311 | 0.388 | 0.624*† ± 0.315 |

TABLE 5

| | Classification | | Ranking | | Regression | |
|---|---|---|---|---|---|---|
| Feature set | Prec at 1 | MRR | Prec at 1 | MRR | Prec at 1 | MRR |
| B | 0.322 ± 0.008 | 0.582 ± 0.003 | 0.333 ± 0.014 | 0.590 ± 0.006 | 0.331 ± 0.020 | 0.586 ± 0.012 |
| B + O | 0.339 ± 0.020 | 0.591 ± 0.012 | 0.352 ± 0.010 | 0.602 ± 0.005 | 0.343 ± 0.017 | 0.595 ± 0.011 |
| B + F | 0.340 ± 0.016 | 0.592 ± 0.007 | 0.345 ± 0.007 | 0.596 ± 0.004 | 0.368 ± 0.013 | 0.611 ± 0.007 |
| B + F + O | 0.356 ± 0.007 | 0.604 ± 0.004 | 0.359 ± 0.006 | 0.605 ± 0.003 | 0.375 ± 0.016 | 0.616 ± 0.008 |
| B + F + O + P | 0.359 ± 0.008 | 0.606 ± 0.005 | 0.361 ± 0.010 | 0.607 ± 0.007 | 0.375 ± 0.015 | 0.614 ± 0.008 |
| B + F + O + C | 0.350 ± 0.011 | 0.600 ± 0.009 | 0.365 ± 0.007 | 0.611 ± 0.003 | 0.381 ± 0.010 | 0.619 ± 0.005 |
| B + F + P + C + P | 0357 ± 0.014 | 0.605 ± 0.008 | 0.363 ± 0.006 | 0.609 ± 0.003 | 0.387 ± 0.009 | 0.622 ± 0.004 |

Table 4 shows the results for classification, ranking, and multilayer regression for each of the five test sets concatenated. That is for the 5 test fold evaluated as one dataset, in order to compute the significance of the mean reciprocal rank results. For mean reciprocal rank, a paired t-test was used. Results indicated with a star are significant at least the p<0.05 level with respect to the baseline. Most of the significant results are significant at the p<0.01 level with respect to the baseline. The precision at one results were not tested for statistical significance, The standard deviation for this metric is not computed because it is not well-defined for binary data.

It can be seen that multilayer regression outperforms both classification and ranking. Further, the correlation features are a significant improvement over the other models. For one third of the examples in the evaluation, the predictor correctly identifies that the first result was clicked, and an MRR of 0.60 indicates that on average the clicked result was between rank one and rank two.

The averages and standard deviation across the five test sets were also computed, see Table 5. As indicated by the standard deviation for the trials, the method is robust to changes in the data set, even for precision at 1 which is in general a much less stable evaluation metric. As already shown for content match weighting the similarity of each component separately and adding features about the degree of overlapping between query and ad improve significantly over the baseline. The best result for each model are achieved by adding the term correlation features.

Sponsored search click data is noisy, possibly more than search clicks. People and fraudulent software might click on ads for reasons that have nothing to do with topical similarity or relevance. While it is not obvious that relevant ads can be distinguished from non-relevant ads based on a user click, the results establish there is enough signal in the clicks that, with a simple method for unbiasing the rank of the click, it is possible to learn and carry out meaningful evaluation without the need for manually produced editorial judgments or complex estimation of click-through rates. Arguably, evaluating a classifier on the task of identifying the ad which will be clicked is more directly related to the task of successfully ranking ads then guessing indirectly the relevance assigned by humans.

The non-linear multilayer perceptron outperforms both the simplest linear models. Interestingly, both linear models perform better when using when using only one of the correlation features (PMI or chi-squared) rather than both, see Table 5. This might depend on the fact that the features are strongly correlated and the linear classifier does not posses enough information to prefer one over the other in case of disagreements. Thus it finds a better solution just by trusting always one over the other. The non-linear model instead has enough expressive power to capture subtler interactions between features and achieves the best results making use of both features. Another interesting aspect is the fact that, although there are only two possible rankings, and thus the problem really boils down to a binary classification task, the linear ranking perceptron clearly outperforms the simpler classifier. The difference seems to lie in the way training is performed, by considering pairwise of patterns. In terms of the features, even the simple word overlap features produced statistically significant results over the baseline model.

Since ad candidates are retrieved by a retrieval system which is treat as a black box, candidates are biased by the initial ad placement algorithm, and it is possible that the initial retrieval system preferred ads with a high degree of lexical overlap with the query, and the word overlap features provided a filter for those ads. The correlation features, which capture related terms rather than matching terms, added a significant amount of discriminative information. Such features are particularly promising because they are effectively language-independent and knowledge free. Similar statistics can be extracted from many resources simple to compile, or even generated by a search engine. Overall, these findings suggest both that relevant ads contain words related to the query and that related terms can be captured efficiently with correlation measures, such as pointwise mutual information and the chi-squared statistic. There are several opportunities for further investigation of this type of features, for example by machine translation modeling.

One limitation of the current way of modeling click data is that “relevance” judgments induced by the logs are strictly binary. For example, using pairwise information is useful in training and it would be desirable to generate more complex multi-valued feedback.

Sponsored search can be thought of as a document retrieval problem, where the ads are the “documents” to be retrieved given a query. As a retrieval problem, sponsored search is difficult because ad materials contain very few terms. Because the language of the ads is so sparse, the vocabulary mismatch problem is even more difficult. In previous approaches, the problem of vocabulary mismatch by generating multiple rewrites of queries to incorporate related terms. In those systems, related terms are derived from user sessions in the query logs, where query rewrites have been identified. The set of possible rewrites is constrained to contain only terms that are found in the database of advertising keywords. They use a machine-learned ranking to determine the most relevant rewrite to match against the ads. In a follow on to this work, active learning has been implemented to select the examples to use in training machine-learned ranking. Both systems were evaluated on manual editorial judgments. By contrast the described method uses click data both for training and evaluating the system. Furthermore, the described models learn a ranking over the ads given a query directly, rather than learning a ranking over query rewrites.

Advertisements are represented in part by their keywords. In one model of online advertising, ads are matched to queries based on the keywords, and advertisers bid for the right to use the keywords to represent their product. So a related task is keyword suggestion, which can be applied to sponsored search or to its sister technology, contextual advertising, which places an ad in a web page based on the similarity between the ad and the web page content.

Contextual advertising is a sister technology to sponsored search, and many of the techniques used to place ads in web pages may be used to place ads in response to a user's query. As with sponsored search, contextual advertising is usually a pay-per-click model, and the ad representations are similar in both sponsored search and contextual advertising. The primary difference is that rather than matching an ad to a query, the system matches the ad to a web page.

Contextual advertising also suffers from the vocabulary mismatch problem. Key differences between contextual advertising methods and the method described in this application include the use of click data in place of human edited relevance judgments (both for learning a ranking function and for evaluation), the application to sponsored search rather than content match, and the use of several different type of classifiers.

An approach to learning and evaluating sponsored search ranking systems based exclusively on click-data is provided. Based on empirical data, the method produces consistent results across different learning models, of varying complexity, and across different feature representations. In addition the method may beneficially learn on pairs of patterns and utilize multilayer regression to provide a competitive platform for ranking from noisy data and compact feature representations. The system includes simple and efficient semantic correlation features provide a valuable source of discriminative information in a complex task such as sponsored search, and thus might possibly useful also in document retrieval and search in general.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

The above description is meant as an illustration of the principles of this application. This description is not intended to limit the scope of this application in that the system is susceptible to modification, variation and change, without departing from spirit of the principles of the application, as defined in the following claims.

We claim:

1. A system for optimizing machine-learned ranking functions based on click data, the system comprising:
a web server configured to collect click data for a set of queries and results;
an advertisement engine configured to determine weighting for each feature of a plurality of features according to an online learning model based the click data; and
wherein the advertisement engine selects an advertisement from a plurality of advertisements for display on a web page based on the weighting of each feature of the plurality of features.

2. The system according to claim 1, wherein the online learning model implements a perceptron algorithm.

3. The system according to claim 1, wherein the online learning model implements a classification algorithm.

4. The system according to claim 3, wherein the classification algorithm is based on the relationship:
α^{t+1}=α^{t}+yₜxᵢ
where y is the actual value, x is the input pattern, α is weighting for the features; t is the number is instances used in training.

5. The system according to claim 1, wherein the online learning model implements a ranking algorithm.

6. The system according to claim 5, wherein the ranking algorithm is based on the relationship:
α^{t+1}=α¹+(x₁−xᵢ)τ
where x is the input pattern, α is weighting for the features; and τ is the positive learning margin.

7. The system according to claim 1, wherein the online learning model implements a multilayer regression algorithm.

8. The system according to claim 7, wherein the multilayer regression algorithm is based on the relationship:
$${α}^{t + 1} = {α}^{t} + η \frac{\partial E}{\partial {α}^{t}} {α}^{t}$$
where α is weighting for the features; η is the learning rate, E is the error of between the input pattern and the actual values; t is the number of instances used in training.

9. The system according to claim 1, wherein the features comprise at least one of word overlap, cosine similarity, and correlation.

10. The system according to claim 1, further comprising evaluating the weighting for each feature by predicting an predictive selected advertisement for a block of advertisements and comparing the predictive selected advertisement with an actually selected advertisement.

11. The system according to claim 1, further comprising ranking the plurality of advertisements based on the weighting.

12. The system according to claim 1, further comprising updating the ranking the plurality of advertisements based on a user click associated with an advertisement of the plurality of advertisements.

13. A method for optimizing machine-learned ranking functions based on click data, method comprising:
determining weighting for each feature of a plurality of features according to an online learning model based on click data;
selecting an element from a plurality of elements for display on a web page based on the weighting of each feature of the plurality of features.

14. The method according to claim 13, wherein the online learning model implements a perceptron algorithm.

15. The method according to claim 13, wherein the online learning model implements a classification algorithm.

16. The method according to claim 15, wherein the classification algorithm is based on the relationship:
α^{t+1}=α^{t}+y₁ᵢ
where y is the actual value, x is the input pattern, α is weighting for the features; t is the number is instances used in training.

17. The method according to claim 13, wherein the online learning model implements a ranking algorithm.

18. The method according to claim 17, wherein the ranking algorithm is based on the relationship:
α^{t+1}=α¹+(x₁−xᵢ)τ
where x is the input pattern, α is weighting for the features; and τ is the positive learning margin.

19. The method according to claim 13, wherein the online learning model implements a multilayer regression algorithm.

20. The method according to claim 19, wherein the multilayer regression algorithm is based on the relationship:
$${α}^{t + 1} = {α}^{t} + η \frac{\partial E}{\partial {α}^{t}} {α}^{t}$$
where α is weighting for the features; η is the learning rate, E is the error of between the input pattern and the actual values; t is the number of instances used in training.

21. The method according to claim 13, wherein the features comprise at least one of word overlap, cosine similarity, and correlation.

22. The method according to claim 13, further comprising evaluating the weighting for each feature by predicting an predictive selected element for a block of elements and comparing the predictive selected element with an actually selected element.

23. The method according to claim 13, further comprising ranking the plurality of elements based on the weighting.

24. The method according to claim 13, further comprising updating the ranking the plurality of elements based on a user click associated with an element of the plurality of elements.

25. A computer readable medium having stored therein instructions executable by a programmed processor for optimizing machine-learned ranking functions based on click data, the computer readable medium comprising instructions for:
determining weighting for each feature of a plurality of features according to an online learning model based on click data;
selecting an element from a plurality of elements for display on a web page based on the weighting of each feature of the plurality of features.

26. The computer readable medium according to claim 25, further comprising evaluating the weighting for each feature by predicting an predictive selected element for a block of elements and comparing the predictive selected element with an actually selected element.

27. The computer readable medium according to claim 25, further comprising ranking the plurality of elements based on the weighting.

28. The computer readable medium according to claim 25, further comprising updating the ranking the plurality of elements based on a user click associated with an element of the plurality of elements.

29. The computer readable medium according to claim 25, wherein the online learning model comprises at least one of a classification algorithm, a ranking algorithm, or a multilayer regression algorithm.
